(19) United States
(12) Patent Application Publication
(10) Pub. No.: US 2025/0106274 A1
(43) Pub. Date: Mar. 27, 2025

(54) ELECTRONIC DEVICE FOR PROVIDING AUDIO SERVICE, AND OPERATION METHOD THEREFOR

(71) Applicant: SAMSUNG ELECTRONICS CO., LTD., Suwon-si (KR)

(72) Inventors: Juyeon JIN, Suwon-si (KR); Hyeeoncho Gi, Suwon-si (KR); Doosuk Kang, Suwon-si (KR); Gupil Cheong, Suwon-si (KR)

(73) Assignee: SAMSUNG ELECTRONICS CO., LTD., Suwon-si (KR)

(21) Appl. No.: 18/974,224

(22) Filed: Dec. 9, 2024

Related U.S. Application Data
(63) Continuation of application No. PCT/KR2023/002157, filed on Feb. 14, 2023.

(30) Foreign Application Priority Data
Jun. 10, 2022 (KR) 10-2022-0071003

(51) Int. Cl. H04L 65/75; H04L 1/00; H04L 27/18; H04W 4/80

(52) U.S. Cl. CPC H04L 65/75; H04L 1/0003; H04L 27/18; H04W 4/80

(57) ABSTRACT

A method by an electronic device, includes: establishing a communication connection configured to use a first codec and a first modulation scheme for an audio service with an external electronic device; determining to use a second codec for reproducing a media file; transmitting, to the external electronic device, a first configuration message indicating the use of the second codec; after transmitting the first configuration message, receiving, from the external electronic device, a first change request message for a change from the first modulation scheme to a second modulation scheme; and transmitting, to the external electronic device, at least one audio packet generated using the second codec by using the second modulation scheme.

### CROSS-REFERENCE TO RELATED APPLICATIONS

This application is a by-pass continuation application of International Application No. PCT/KR2023/002157, filed on Feb. 14, 2023, which is based on and claims priority to Korean Patent Application No. 10-2022-0071003, filed on Jun. 10, 2022, in the Korean Intellectual Property Office, the disclosures of which are incorporated by reference herein their entireties.

### BACKGROUND

### 1. Field

The disclosure relates to an electronic device for providing an audio service and a method of operating the electronic device.

### 2. Description of Related Art

A Bluetooth™ (hereinafter, “Bluetooth”) communication technology may suggest a short-range wireless communication technology capable of enabling electronic devices to be connected to each other in order to exchange data or information. The Bluetooth communication technology may include a Bluetooth legacy (or classic) communication technology or a Bluetooth low energy (BLE) communication technology, and may have topology in various connection forms such as piconet or scatternet.

Recently, electronic devices using the Bluetooth communication technology, such as a pair of ear buds, have been widely used. The ear-wearable device may provide various functions. For example, the ear-wearable device may include a microphone to identify a user's voice and to transmit data based on the user's voice to an electronic device (for example, a smartphone). Further, the ear-wearable device may include a speaker to output audio data received from the electronic device (for example, the smartphone) through the speaker.

The ear-wearable device may include a primary ear bud (for example, a right ear bud) and a secondary ear bud (for example, a left ear bud) that can be connected to the electronic device (for example, the smartphone). The primary ear bud may transmit voice data to the electronic device through the connection with the electronic device, and the electronic device may transmit audio data (or audio content) to the primary ear bud. The primary ear bud may transfer the audio data (or audio content) received from the electronic device through wireless communication to the secondary bud and output the audio data through the speaker. The secondary ear bud may be synchronized with the primary ear bud and output the audio data received from the primary ear bud or the electronic device through the speaker.

The electronic device supporting the Bluetooth technology such as the primary ear bud and the secondary ear bud (hereinafter, referred to “ear buds”) may be connected to a counterpart device (for example, a smartphone), based on Bluetooth communication to perform the above operations.

A Bluetooth device may support various modulation schemes, for example, Gaussian frequency-shift keying (GFSK), π/4 differential quadrature phase-shift keying (DQPSK), and 8-differential phase-shift keying (DPSK) in order to perform data (for example, audio data) communication with a counterpart device. For example, GPSK may support a data rate of 1 M bit per second (Mbps), π/4 DQPSK may support a data rate of 2 Mbps, and 8 DPSK may support a data rate of 3 Mbps. Further, additional modulation schemes that aim at a higher data rate (for example, a data rate higher than 3 Mbps) may be supported in Bluetooth technology.

The Bluetooth device (for example, ear buds) may basically use the modulation scheme of 2 Mbps (for example, π/4 DQPSK) by RX sensitivity. However, it may be difficult for the Bluetooth device to receive audio data at a desired bit rate even though a maximum size packet of the modulation scheme of 2 Mbps is used for high-quality audio data transmission. Accordingly, the Bluetooth device may need a change to a modulation scheme in which larger amounts of data can be received in a specific situation.

### SUMMARY

The disclosure appropriately changes a modulation scheme while an audio service is provided between electronic devices performing Bluetooth communication.

Provided is an electronic device for making a request for a change to a modulation scheme required for high-capacity data transmission in order to improve audio quality, and a method of operating the electronic device.

Provided is an electronic device for making a change to a modulation scheme required for high-capacity data transmission in order to improve audio quality, and a method of operating the electronic device.

According to an aspect of the disclosure, an electronic device includes: a communication circuit; memory storing instructions; and at least one processor operatively connected to the communication circuit and the memory, wherein the instructions, when executed by the at least one processor individually or collectively, cause the electronic device to: establish a communication connection configured to use a first codec and a first modulation scheme for an audio service with an external electronic device through the communication circuit; determine to use a second codec for reproducing a media file; transmit, to the external electronic device through the communication circuit, a first configuration message indicating the use of the second codec; after transmitting the first configuration message, receive, through the communication circuit from the external electronic device, a first change request message for a change from the first modulation scheme to a second modulation scheme; and transmit, to the external electronic device through the communication circuit, at least one audio packet generated using the second codec by using the second modulation scheme.

According to an aspect of the disclosure, an electronic device includes: a communication circuit; memory storing instructions; and at least one processor operatively connected to the communication circuit and the memory, wherein the instructions, when executed by the at least one processor individually or collectively, cause the electronic device to: establish a communication connection configured to use a first codec and a first modulation scheme for an audio service with an external electronic device through the communication circuit; receive, from the external electronic device through the communication circuit, a first configuration message indicating use of a second codec for the communication connection; determine whether a modulation scheme change is needed based on the second codec; based on determining that the modulation scheme change is needed, transmit a first change request message for a change from the first modulation scheme to a second modulation scheme to the external electronic device through the communication circuit; and receive, from the external electronic device through the communication circuit, at least one audio packet generated using the second codec by using the second modulation scheme.

According to an aspect of the disclosure, a method by an electronic device, includes: establishing a communication connection configured to use a first codec and a first modulation scheme for an audio service with an external electronic device; determining to use a second codec for reproducing a media file; transmitting, to the external electronic device, a first configuration message indicating the use of the second codec; after transmitting the first configuration message, receiving, from the external electronic device, a first change request message for a change from the first modulation scheme to a second modulation scheme; and transmitting, to the external electronic device, at least one audio packet generated using the second codec by using the second modulation scheme.

According to an aspect of the disclosure, a method of operating an electronic device, includes: establishing a communication connection configured to use a first codec and a first modulation scheme for an audio service with an external electronic device; receiving, from the external electronic device, a first configuration message indicating use of a second codec for the communication connection; determining whether a modulation scheme change is needed based on the second codec; in case that the modulation scheme change is needed, transmitting, to the external electronic device, a first change request message for a change from the first modulation scheme to a second modulation scheme; and receiving, from the external electronic device, audio data generated using the second codec by using the second modulation scheme.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates an electronic device within a network environment according to one or more embodiments;

FIG. 2 illustrates an example of a connection between electronic devices based on Bluetooth according an embodiment;

FIG. 3 illustrates a configuration of the electronic device supporting Bluetooth communication according to an embodiment;

FIG. 4 illustrates establishment of a Bluetooth connection according to an embodiment;

FIGS. 5A and 5B illustrate a procedure of changing a modulation scheme according to embodiments;

FIG. 6 illustrates a codec negotiation procedure for Bluetooth communication according to an embodiment.

FIG. 7A, FIG. 7B, and FIG. 7C illustrate formats of data packets transmitted through Bluetooth communication according to embodiments;

FIG. 8 illustrates a procedure of making a request for changing a modulation scheme according to an embodiment;

FIG. 9 illustrates operations of the electronic device according to an embodiment;

FIG. 10 illustrates operations of the external electronic device according to an embodiment;

FIG. 11 illustrates a procedure of changing a modulation scheme according to an embodiment;

FIG. 12 illustrates a procedure of changing a modulation scheme by the electronic device according to an embodiment; and

FIG. 13 illustrates a format of a change induction message according to an embodiment.

### DETAILED DESCRIPTION

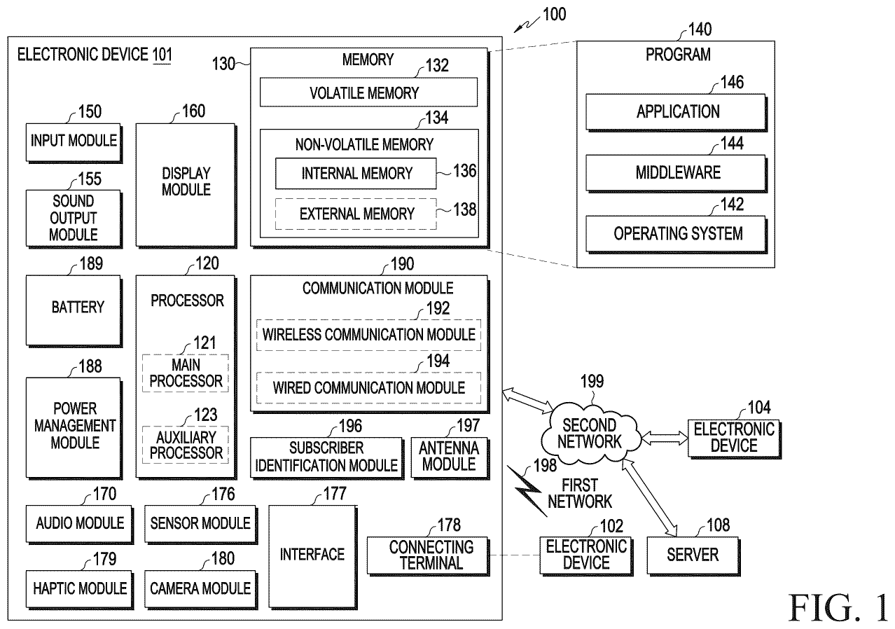

FIG. 1 is a block diagram illustrating an electronic device 101 in a network environment 100 according to an embodiment.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to an embodiment, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to (or based on) a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra-low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

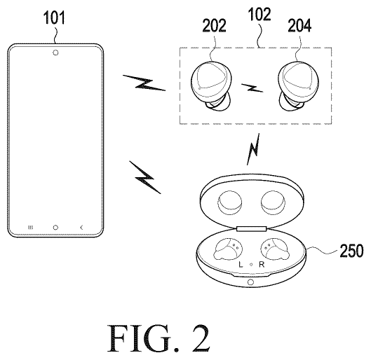

FIG. 2 illustrates an example of a connection between electronic devices, based on a Bluetooth scheme, according to an embodiment.

Referring to FIG. 2, the electronic device 101 may be wirelessly connected to the external electronic device 102 (for example, an ear-wearable device). In an embodiment, the electronic device 101 may be a smartphone. In an embodiment, the external electronic device 102 is a both ear-split ear wearable device and may include at least one of a first external electronic device 202 (for example, a left ear bud) and a second external electronic device 204 (for example, a right ear bud).

In an embodiment, the first external electronic device 202 and the second external electronic device 204 are illustrated as a pair of ear buds, but the first external electronic device 202 and the second external electronic device 204 may include all of devices capable of operating as one pair as well as ear buds. According to an embodiment, the first external electronic device 202 and the second external electronic device 204 may be implemented to include the same or similar elements.

According to an embodiment, the electronic device 101 may configure a connection (for example, a Bluetooth communication link) with at least one of the first external electronic device 202 and the second external electronic device 204, and transmit and/or receive data to/or from each other. For example, the electronic device 101 may configure a communication link with at least one of the first external electronic device 202 and the second external electronic device 204, based on a Wi-Fi scheme or a Bluetooth scheme, but a scheme in which the electronic device 101 configures the communication link with the first external electronic device 202 and the second external electronic device 204 is not limited to at least one of the Wi-Fi scheme or the Bluetooth scheme.

In an embodiment, the electronic device 101 may configure the communication link with only one of the first external electronic device 202 and the second external electronic device 204 or configure individual communication links with the first external electronic device 202 and the second external electronic device 204, respectively.

In an embodiment, when the external electronic device 102 includes the first external electronic device 202 and the second external electronic device 204, the first external electronic device 202 and the second external electronic device 204 may configure the communication link therebetween, based on at least one of the Wi-Fi scheme and/or the Bluetooth scheme, but the scheme in which the first external electronic device 202 and the second external electronic device 204 configure the communication link is not limited to at least one of the Wi-Fi scheme and/or the Bluetooth scheme.

In an embodiment, the electronic device 101 may operate as a central (or a master, a primary device, or a main), and the first external electronic device 202 and the second external electronic device 204 may operate as peripherals (or slaves, secondary devices, or sub devices). The electronic device 101 operating as the central may transmit data to the external electronic device 102 operating as the peripheral. In the case of an audio service, the electronic device 101 operating as the central may be a source electronic device and the external electronic device 102 operating as the peripheral may be a sink electronic device.

In an embodiment, one of the first external electronic device 202 and the second external electronic device 204 may operate as the central and the other one may operate as the peripheral. For example, when the first external electronic device 202 and the second external electronic device 204 configures the communication link, one of the first external electronic device 202 and the second external electronic device 204 may be randomly selected as the central and the other one may be selected as the peripheral.

The first external electronic device 202 and the second external electronic device 204 may directly or indirectly communicate with a third external electronic device 250. In an embodiment, the third external electronic device 300 may be an ear buds case device or a cradle device that keeps and charges the first external electronic device 202 and the second external electronic device 204.

In an embodiment, the first external electronic device 202 or the second external electronic device 204 may generate an advertising signal including its own information (for example, a Bluetooth media access control (MAC) address) in a multicast manner or a broadcast manner. The electronic device 101 may discover the existence of the first external electronic device 202 or the second external electronic device 204 by receiving the advertising signal. The advertising signal may provide information related to a connection or an account (for example, pairing) to unspecified neighboring electronic devices (for example, the electronic device 101). In an embodiment, when the case device opens in the state where the first external electronic device 202 or the second external electronic device 204 is stored in the third external electronic device 300, the first external electronic device 202 or the second external electronic device 204 may start transmitting the advertising signal.

In an embodiment, when the first external electronic device 202 or the second external electronic device 204 is recognized and a Bluetooth connection with the first external electronic device 202 or the second external electronic device 204 is made, the electronic device 101 may transit data (for example, audio data or voice data) through the Bluetooth connection.

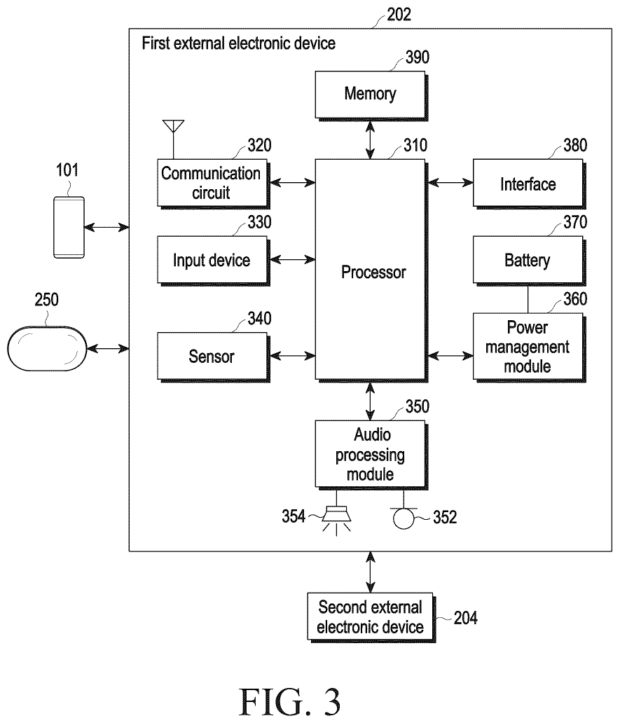

FIG. 3 illustrates a configuration of the electronic device supporting Bluetooth communication according to an embodiment.

Referring to FIG. 3, the electronic device 101 may be wirelessly connected to the external electronic devices 202 and 204. The electronic device 101 may be implemented as, for example, a smartphone, but is not limited to the description and/or illustration and may be implemented as various types of devices (for example, notebook computers including a standard notebook, an Ultra Book, a netbook, and a Tab Book, a laptop computer, a tablet computer, or a desktop computer). In an embodiment, the electronic device 101 may be implemented as illustrated in FIG. 1, and accordingly may include at least some of the configurations (for example, various modules) illustrated in FIG. 1, and thus overlapping description is omitted.

The external electronic devices 202 and 204 may be implemented as wireless ear buds, but are not limited to the description and/or illustration and may be implemented as various types of devices (for example, a smart watch or a head-mounted display device) supporting an audio service described below. According to an embodiment, when the external electronic devices 202 and 204 are wireless ear buds, the external electronic devices 202 and 204 may be a pair of devices (for example, a left ear bud and a right ear bud). According to an embodiment, the first external electronic device 202 and the second external electronic device 204 may be implemented to have the same or similar configurations.

According to an embodiment, the electronic device 101 may configure a communication connection with at least one of the external electronic devices 202 and 204 and transmit and/or receive data to and/or from each other. For example, each of the external electronic devices 202 and 204 may configure the communication connection through the use of device-to-device (D2D) communication such as Wi-Fi direct or Bluetooth (for example, the use of a communication circuit supporting the corresponding communication scheme), but is not limited thereto and may communicate with each other through the use of various types of communication (for example, a communication scheme such as Wi-Fi using an access point (AP), a cellular communication scheme using a base station, or a wired communication scheme).

In an embodiment, the electronic device 101 may make a connection of the communication link with only one (for example, a primary ear bud) of the first external electronic device 202 and the second external electronic device 204 or may make a connection of each of the communication links with both the first external electronic device 202 and the second external electronic device 204.

In an embodiment, the first external electronic device 202 and the second external electronic device 204 may configure the communication connection to each other and transmit and/or receive data (for example, audio data and/or control data) to and/or from each other. The communication connection may be configured using a D2D communication such as Wi-Fi direct or Bluetooth (for example, using a communication circuit supporting the corresponding communication) but is not limited thereto.

In an embodiment, one of the first external electronic device 202 and the second external electronic device 204 may be a primary device (or a master device or a main device), the other device may be a secondary device (or a slave device or a sub device), and the primary device (or the main device) may transmit data to the secondary device. For example, when the first external electronic device 202 and the second external electronic device 204 configure the communication connection to each other, one of the first external electronic device 202 and the second external electronic device 204 may be randomly selected as the primary device, and the other device may be selected as the secondary device. In an embodiment, when the first external electronic device 202 and the second external electronic device 204 configure the communication connection to each other, a device that is first detected to be worn on a human body (for example, of which a value indicating wearing is detected using a sensor for detecting wearing (for example, a proximity sensor, a touch sensor, a tilt 6-axis sensor, or 9-axis sensor)), and the other device may be selected as the secondary device.

In an embodiment, the primary device may transmit the data received from the electronic device 101 to the secondary device. For example, the first external electronic device 202 that is the primary device may not only output an audio to a speaker 354, based on audio data received from the electronic device 101 but also transmit the audio data to the second external electronic device 204 that is the secondary device. In an embodiment, the secondary device may receive audio data transmitted from the electronic device 101 to the primary device (for example, the first external electronic device 202) through sniffing, based on connection information provided from the primary device (for example, the first external electronic device 202).

In an embodiment, the first external electronic device 202 that is the primary device may transmit data (for example, audio data or control data) received from the second external electronic device 204 that is the secondary device to the electronic device 101. For example, when a touch event is generated in the second external electronic device 204 that is the secondary device, control data including information on the generated touch event may be transmitted to the electronic device 101 by the first external electronic device 202 that is the primary device. However, it is not limited thereto, and, as described above, the second device and the electronic device 101 may configure the communication connection to each other and accordingly, data transmission and/or reception may be directly performed between the secondary device and the electronic device 101.

In an embodiment, the first external electronic device 202 may include elements that are the same as or similar to at least one of the elements (for example, modules) of the electronic device 101 illustrated in FIG. 1. In an embodiment, the first external electronic device 202 may include at least one of a processor 310 (for example, the processor 120 of FIG. 1), a communication circuit 320 (for example, the communication module 190 of FIG. 1), an input device 330 (for example, the input module 150 of FIG. 1), a sensor 340 (for example, the sensor module 176 of FIG. 1), an audio processing module 350 (for example, the audio module 170 of FIG. 1), a power management module 360 (for example, the power management module 188 of FIG. 1), a battery 370 (for example, the battery 189 of FIG. 1), an interface 380 (for example, the interface 177 of FIG. 1), or memory 390 (for example, the memory 130 of FIG. 1).

According to an embodiment, the communication circuit 320 may include at least one of a wireless communication module (for example, a Bluetooth communication module, a cellular communication module, a wireless-fidelity (Wi-Fi) communication module, a near field communication (NFC) communication module, or a global navigation satellite system (GNSS) communication module) or a wired communication module (for example, a local area network (LAN) communication module or a power line communication (PLC) module). As an example, the Bluetooth communication module may support at least one communication connection (for example, communication link) by Bluetooth legacy communication and/or Bluetooth low energy (BLE) communication.

The communication circuit 320 may directly or indirectly communicate with at least one of the electronic device 101 (for example, the smartphone), the third external electronic device 250 (for example, the charging device such as a cradle), or the second external electronic device 204 (for example, the secondary ear bud) through a first network (for example, the first network 198 of FIG. 1) by using at least one communication module included therein. The second external electronic device 204 may be configured as a pair with the first external electronic device 202. The communication circuit 320 may operate independently from the processor 310 and may include one or more communication processors supporting wired or wireless communication.

According to an embodiment, the communication circuit 320 may be connected to one or a plurality of antennas that can transmit signals or information to another electronic device (for example, at least one of the electronic device 101, the second external electronic device 204, or a cradle device (for example, the third external electronic device 250)) or receive the same from another electronic device. According to an embodiment, at least one antenna suitable for a communication scheme used in a communication network such as the first network (for example, the first network 198 of FIG. 1) or a second network (for example, the second network 199 of FIG. 2) may be selected from the plurality of antennas by, for example, the communication circuit 320. The signals or information may be transmitted or received between the communication circuit 320 and another electronic device through at least one selected antenna.

According to an embodiment, the input device 330 may be configured to generate various input signals that can be used for the operation of the first external electronic device 202. The input device 330 may include at least one of a touch pad, a touch panel, or a button.

According to an embodiment, the input device 330 may generate a user input for on or off of the first external electronic device 202. According to an embodiment, the input device 330 may receive a user input for the communication connection between the first external electronic device 202 and the second external electronic device 204. According to an embodiment, the input device 330 may receive a user input related to audio data (or audio content). For example, the user input may be associated with a function of starting reproduction of audio data, pausing the reproduction, stopping the reproduction, controlling a reproduction speed, controlling a reproduction volume, and/or controlling muting.

According to an embodiment, the sensor 340 may measure or identify a location or an operating state of the first external electronic device 202. The sensor 340 may convert the measured or identified information into an electrical signal. The sensor 340 may include at least one of, for example, a magnetic sensor, an acceleration sensor, a gyro sensor, a geomagnetic sensor, a proximity sensor, a gesture sensor, a grip sensor, a biometric sensor, or an optical sensor.

According to an embodiment, the processor 310 may detect data (for example, audio data) from a data packet received from the electronic device 101, process the detected data through the audio processing module 350, and output the data to the speaker 354. The audio processing module 350 may support an audio data collection function and reproduce the collected audio data.

According to an embodiment, the audio processing module 350 may include an audio decoder and a D/A converter. The audio decoder may convert audio data stored in the memory 390 or received from the electronic device 101 through the communication circuit 320 into a digital audio signal. The D/A converter may convert the digital audio signal converted by the audio decoder into an analog audio signal. According to an embodiment, the audio decoder may convert audio data received from the electronic device 101 through the communication circuit 320 and stored in the memory 390 into a digital audio signal. The speaker 354 may output the analog audio signal converted by the D/A converter.

According to an embodiment, the audio processing module 350 may include an A/D converter. The A/D converter may convert an analog voice signal collected through the microphone 352 into a digital voice signal. The microphone 352 may include at least one air conduction microphone and/or at least one bone conduction microphone for detecting voices and/or sounds.

According to an embodiment, the audio processing module 350 may reproduce various pieces of audio data configured according to an operational operation of the first external electronic device 202. For example, the processor 310 may be designed to detect, through the sensor 340, that the first external electronic device 202 is combined with or detached from the user's ear and reproduce audio data on an effect sound or a notification sound through the audio processing module 350. Outputting the effect sound or the notification sound may be omitted according to user's settings or designer's intent.

According to an embodiment, the memory 390 may store various pieces of data used by at least one element (for example, the processor 310 or the sensor 340) of the first external electronic device 202. Data may include, for example, input data or output data on software and commands related thereto. The memory 390 may include volatile memory or nonvolatile memory.

According to an embodiment, the power management module 360 may manage power supplied to the first external electronic device 202. According to an embodiment, the power management module 360 may be implemented as, for example, at least a part of a power management integrated circuit (PMIC). According to an embodiment, the power management module 360 may include a battery charging module. According to an embodiment, when another electronic device (for example, one of the electronic device 101, the second external electronic device 204, or another electronic device) is electrically connected (wirelessly or wiredly) to the first external electronic device 202, the power management module 360 may receive power from the other electronic device and charge the battery 370.

According to an embodiment, the battery 370 may supply power to at least one element of the first external electronic device 202. The battery 370 may include, for example, a rechargeable battery. According to an embodiment, when the first external electronic device 202 is mounted to the inside of the cradle device (for example, the third external electronic device 250), the first external electronic device 202 may charge the battery 370 up to a predetermined charging level and then turn on power of the first external electronic device 202 or turn on at least a part of the communication circuit 320.

According to an embodiment, the interface 380 may support one or more predetermined protocols that can be used to directly (for example, wiredly) connect the first external electronic device 202 with the electronic device 101, the second external electronic device 204, the cradle device (for example, the third external electronic device 250), or another electronic device. The interface 380 may include at least one of, for example, a high definition multimedia interface (HDMI), a USB interface, an SD card interface, a power line communication (PLC) interface, or an audio interface. According to an embodiment, the interface 380 may include at least one connection port for establishing a physical connection with the cradle device (for example, the third external electronic device 250).

According to an embodiment, the processor 310 may execute software to control at least one other element (for example, hardware or software component) of the first external electronic device 202 connected to the processor 310 and perform various data processing or calculations. According to an embodiment, as at least a part of the data processing or calculations, the processor 310 may load a command or data received from another element (for example, the sensor 340 or the communication circuit 320) to the volatile memory 390, process the command or data stored in the volatile memory 390, and store resultant data in the nonvolatile memory.

According to an embodiment, the processor 310 may establish the communication connection with the electronic device 101 through the communication circuit 320 and receive data (for example, audio data) from the electronic device 101 through the established communication connection. According to an embodiment, the processor 310 may transmit the data received from the electronic device 101 through the communication circuit 320 to the second external electronic device 204. According to an embodiment, the processor 310 may perform operations of the first external electronic device described below. According to an embodiment, the processor 310 may include a physical layer, a link layer, a host, and an application layer for performing Bluetooth communication.

According to one or more embodiments, the first external electronic device 202 may further include at least one of various modules according to the provision form thereof. Since such elements may be variously modified according to the trend toward convergence of digital devices, the elements cannot all be enumerated. However, the first external electronic device 202 may further include elements equivalent to the aforementioned elements. Further, the first external electronic device 202 according to one or more embodiments can exclude a specific element from the elements or replace the same with another element according to the provision form thereof. This may be easily understood by those skilled in the art.

According to an embodiment, the second external electronic device 204 configured as a pair with the first external electronic device 202 may include elements that are the same as or similar to those included in the first external electronic device 202 and may perform all or some of the operations of the first external electronic device 202 described in the drawings described below.

The electronic device 101 may discover at least one of the external electronic devices 202 and 204 through a Bluetooth scan and establish a Bluetooth connection with the discovered external electronic device. At least one of the external electronic devices 202 and 204 may perform advertising to be discovered by the electronic device 101. Hereinafter, embodiments including operations between the electronic device 101 and the external electronic device 202 will be described, but the same description can be applied between the electronic device 101 and the external electronic device 204.

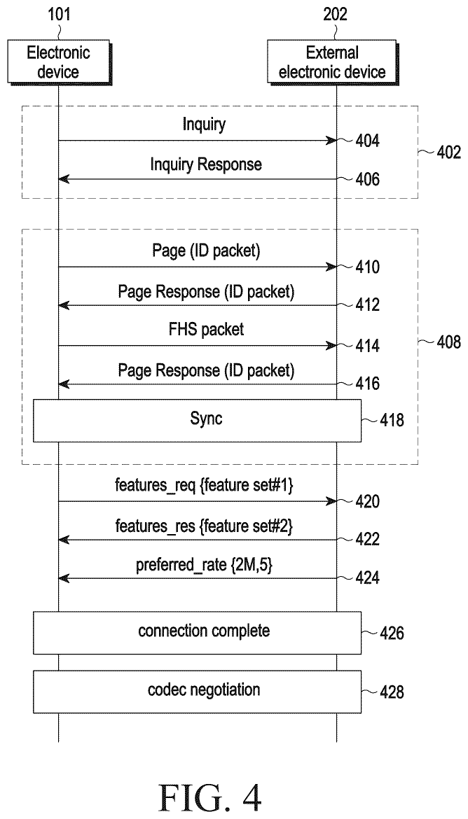

FIG. 4 illustrates establishment of a Bluetooth connection according to an embodiment. According to embodiments, at least some of the operations described below may be omitted or transformed, or the order thereof may be changed.

Referring to FIG. 4, in operation 402, the electronic device 101 may perform an inquiry procedure for searching for neighboring Bluetooth devices. In an embodiment, operation 402 may include operation 404 and operation 406.

In operation 404, the electronic device 101 may broadcast an inquiry packet including its own inquiry address code (IAC). In an embodiment, operation 404 may be repeated at least once before an inquiry response packet of operation 406 is received. In operation 406, the external electronic device (for example, the external electronic device 202) may receive the inquiry packet to discover the electronic device 101 and transmit an inquiry response packet including its own frequency hopping sequence (FHS) to the electronic device 101 in response to (or based on) the inquiry packet. Through the inquiry procedure of operation 402, the electronic device 101 may discover the external electronic device 202.

In operation 408, the electronic device 101 may perform a paging procedure with the external electronic device 202. In an embodiment, operation 408 may include operation 410, operation 412, operation 414, operation 416, and operation 418. In operation 410, the electronic device 101 may broadcast an ID packet for paging. In an embodiment, the ID packet may include a device access code (DAC) of the electronic device 101. In an embodiment, operation 410 may be repeated at least once before the paging response of operation 412 is received. In operation 412, the external electronic device 202 may transmit the ID packet including the DAC to the electronic device 101 for the paging response. In operation 414, the electronic device 101 may transmit an FHS packet for frequency hopping synchronization to the external electronic device 202. In operation 416, the external electronic device 202 may transmit the ID packet including the DAC to the electronic device 101 for a second paging response (second reply). In operation 418, the external electronic device 202 may be synchronized with the electronic device 101.

In an embodiment, the paging procedure of operation 408 may be initiated by transmission of the ID packet for paging by the external electronic device 202, and the electronic device 101 may receive the ID packet through the page scan and transmit the paging response to the external electronic device 202. Through the paging procedure, the external electronic device 202 may be synchronized with the electronic device 101.

In an embodiment, the electronic device 101 and the external electronic device 202 may share available functions (features) through operation 420 and operation 422. For example, the functions may include at least one of a modulation scheme, the number of slots, or a data rate. In operation 420, the electronic device 101 may transmit a function request message (for example, “feature_req”) including a first function set (for example, feature_set #1) supported by the electronic device 101 to the external electronic device 202. In an embodiment, the first function set may include one or more functions that the electronic device 101 desires to use for Bluetooth communication with the external electronic device 202 or one or more functions supported by the electronic device 101. In an embodiment, the first function set may include at least one of information indicating whether basic Bluetooth functions such as at least one of sniff, role switch, page scan, or adaptive frequency hopping (AFH) are supported, the number of supportable slots, or a supportable data rate.

In an embodiment, the supportable data rate may correspond to the modulation scheme. In an embodiment, it may be determined that a data rate of 1 Mbps is used with GPSK, a data rate of 2 Mbps is used with π/4 DQPSK, and a data rate of 3 Mbps is used with 8 DPSK. In an embodiment, the electronic device 101 may include, in the first function set, one or more data rates (for example, 2 Mbps and 3 Mbps) corresponding to one or more modulation schemes that are desired to be used for Bluetooth communication with the external electronic device 202.

In an embodiment, the number of supportable slots may correspond to a packet size. One channel having a predetermined bandwidth may be split into, for example, slots having predetermined time duration, and a packet may be transmitted through at least one slot. A basic length of one slot may be, for example, 625 μs, and a transmission time unit of one packet may expand up to, for example, 3.125 ms according to a payload length. For example, one packet may be transmitted through one slot to a maximum of 5 slots. The electronic device 101 may include, in the first function set, the number of one or more slots (for example, three or five) that are desired to be used for Bluetooth communication with the external electronic device 202.

In operation 422, the external electronic device 202 may determine a second function set (for example, feature_set #2), based on the first function set included in the function request message and transmit a function response message (for example, “features_res”) including the second function set to the electronic device 101. In an embodiment, the second function set may include some or all of the first function set. In an embodiment, the external electronic device 202 may include, in the second function set, at least one data rate supported by the external electronic device 202 among one or more data rates included in the first function set.

In an embodiment, when the external electronic device 202 initiates paging in operation 408, the external electronic device 202 may operate as a master, the function request message of operation 420 may be transmitted to the electronic device 101 by the external electronic device 202, and the function response message of operation 422 may be transmitted to the external electronic device 202 by the electronic device 101.

Through operation 420 and operation 422, the electronic device 101 and the external electronic device 202 may share the same function set (for example, the second function set) and perform Bluetooth communication by using the function set by default. When the function set includes 2 Mbps, 3 Mbps, and 5 slots, the electronic device 101 may transmit audio data to the external electronic device 202 by using any of the modulation scheme of 2 Mbps (for example, π/4 DQPSK) and the modulation scheme of 3 Mbps (for example, 8 DPSK). When the external electronic device 202 supports the modulation scheme of 2 Mbps and does not support the modulation scheme of 3 Mbps, the function set may include 2 Mbps and 5 slots, and the electronic device 101 may transmit audio data to the external electronic device 202 by using the modulation scheme of a maximum of 2 Mbps.

In operation 424, the external electronic device 202 may transmit a preferred rate message (for example, “preferred_rate”) for making a request for a preferred data rate to the electronic device 101 for receive (RX) sensitivity). In an embodiment, when the external electronic device 202 does not configure the preferred data rate, operation 424 may be omitted. In an embodiment, when the external electronic device 202 establishes the Bluetooth connection with the electronic device 101 or during Bluetooth communication, the external electronic device 202 may transmit the preferred rate message in order to selectively use at least one of various packet types by using a channel quality-based data rate (channel quality driven data rate). In an embodiment, when the preferred data rate is not configured, the electronic device 202 may use a modulation scheme and the number of slots that have the highest priority.

In an embodiment, [Table 1] shows various packet types used for Bluetooth communication.

TABLE 1

| | | | | Asymmetric | Asymmetric |
|---|---|---|---|---|---|
| | | | Symmetric | Forward | Reverse |
| Type | Data rate | Slot # | Transfer | Transfer | Transfer |
| DM1 | 1M | 1 | 108.8 | 108.8 | 108.8 |
| DH1 | 1M | 1 | 172.8 | 172.8 | 172.8 |
| DM3 | 1M | 1 | 258.1 | 387.2 | 54.4 |
| DH3 | 1M | 1 | 390.4 | 585.6 | 86.4 |
| DM5 | 1M | 1 | 286.7 | 477.8 | 36.3 |
| DH5 | 1M | 1 | 433.9 | 723.2 | 57.6 |
| AUX1 | 1M | 1 | 185.6 | 185.6 | 185.6 |
| 2-DH1 | 2M | 1 | 345.6 | 345.6 | 345.6 |
| 2-DH3 | 2M | 3 | 782.9 | 1174.4 | 172.8 |
| 2-DH5 | 2M | 5 | 869.1 | 1448.5 | 115.2 |
| 3-DH1 | 3M | 1 | 531.2 | 531.2 | 531.2 |
| 3-DH3 | 3M | 3 | 1177.6 | 1766.4 | 235.6 |
| 3-DH5 | 3M | 5 | 1306.9 | 2178.1 | 177.1 |

Referring to [Table 1], DMx indicates medium-speed data (data-medium rate), DHx indicates high-speed data (data-high rate), and AUX indicates auxiliary data. In an embodiment, each packet type may include a modulation scheme and a packet size. For example, in the packet type, 2-DH3 may mean a modulation scheme and 3 slots corresponding to a data rate of 2 Mbps. In an embodiment, modulation schemes may be divided into a basic rate (BR) (for example, 1 Mbps) and an enhanced data rate (EDR) (for example, 2 Mbps or 3 Mbps). The EDR can perform transmission of relatively larger amounts of data compared to the BR, but may be vulnerable to a busy wireless environment. On the other hand, the BR is robust in the busy wireless environment but is not able to transmit large amounts of data.

In an embodiment, packet sizes may include 1 slot, 3 slots, and 5 slots. The packet size of 5 slots can transmit large amounts of data through one transmission but may be vulnerable to a surrounding wireless environment. The packet size of 1 slot is robust in the surrounding wireless environment but is not able to transmit large amounts of data. The external electronic device 202 may determine at least one of 1 Mbps, 2 Mbps, or 3 Mbps, and at least one of 1 slot, 3 slots, or 5 slots, based on various factors such as a reception quality of a communication circuit (for example, the communication circuit 320), for example, a bit error rate, a packet error rate, or received signal strength (received signal strength indicator).

In an embodiment, the external electronic device 202 may transmit the preferred rate message of operation 424 making a request for using 2 Mbps by default in order to improve reception sensitivity although both 2 Mbps and 3 Mbps are supported. For example, the preferred rate message may include information indicating at least one of 2 Mbps or 5 slots. In response to reception of the preferred rate message, the electronic device 101 may determine that the modulation scheme (for example, π/4 DQPSK) corresponding to a maximum of 2 Mbps can be used to generate a data packet transmitted to the external electronic device 202.

In operation 426, the electronic device 101 and the external electronic device 202 may complete the Bluetooth connection. In an embodiment, operation 426 may include an operation in which the electronic device 101 transmits a connection request message to the external electronic device 202 and receives an accept message from the external electronic device 202 and an operation in which the electronic device 101 and the external electronic device 202 exchange a setup complete message.

In operation 428, the electronic device 101 and the external electronic device 202 may perform a codec negotiation of sharing a codec list that can be used for communication of audio data through the Bluetooth communication and setting a codec to be used. In an embodiment, the codec negotiation procedure of operation 428 may be initiated to negotiate available codecs in one of the electronic device 101 or the external electronic device 202. In an embodiment, the codec negotiation procedure of operation 428 may be selectively performed when the Bluetooth connection is established or during Bluetooth communication. The codec negotiation procedure of operation 428 may be initiated by one of the electronic device 101 or the external electronic device 202.

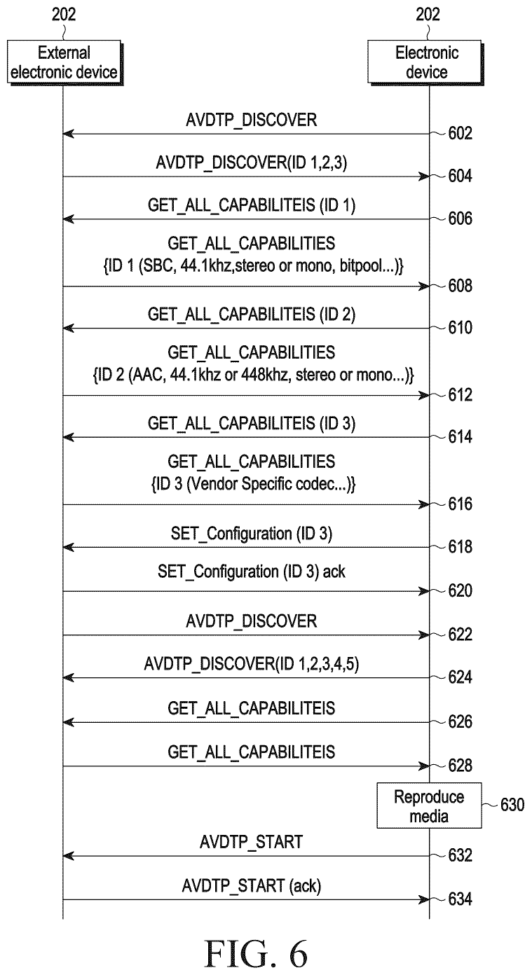

In an embodiment, the codec negotiation procedure of operation 428 may include at least some of the operations of FIG. 6. In an embodiment, the codec negotiation procedure may include an operation (for example, operation 608, operation 612, or operation 616) in which the external electronic device 202 transmits codec information indicating one or more codecs supported by the external electronic device 202 to the electronic device 101. For example, the one or more codecs may include at least one of sub-band codec, advanced audio coding (AAC), audio processing technology-X (aptX), Samsung scalable codec (SSC), or ultra-high quality (UHQ). Each codec may define a sample frequency, a bit rate, and a compression rate. For example, SBC may include 16 bit/48 kHz, 345 kbps, and a compression rate of 1/20, aptX may include 16 bit/44.1 kHz, 352 kbps, and a compression rate of ¼, and AAC may include 16 bit/44.1 KHz, 250 Kbps, and variable compression.

In an embodiment, during the codec negotiation procedure, the electronic device 101 or the external electronic device 202 may select and set one codec (for example, default codec) having a high priority in the shared codec list. In an embodiment, the electronic device 101 or the external electronic device 202 may make a request for using another codec in the codec list, rather than the default codec, to a counterpart device in order to perform high sound quality audio transmission. When the codec capable of performing high sound quality audio transmission is applied, it may be difficult to achieve a bit rate for high sound quality audio transmission even though a packet having the maximum size that can be generated through the modulation scheme corresponding to 2 Mbps. In an embodiment, when it is determined to use a high sound quality codec (for example, an ultra-high quality codec) according to a user input or a given situation (for example, a communication quality), the external electronic device 202 or the electronic device 101 may change a packet type (for example, at least one of a modulation scheme, the number of slots, or a data rate) to make transmission of data in larger size possible. For example, the default modulation scheme (for example, the modulation scheme corresponding to 2 Mbps) configured in operation 424 may be changed to the modulation scheme corresponding to 3 Mbps to support the UHQ codec.

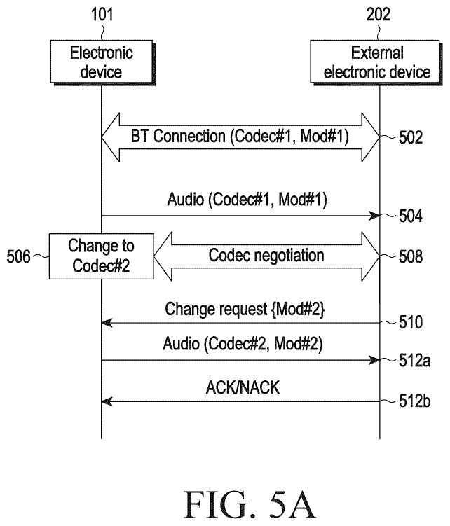

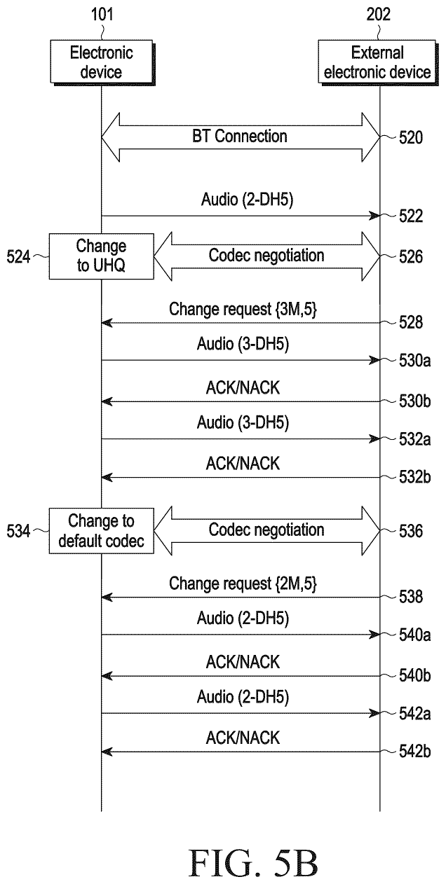

FIG. 5A illustrates a procedure of changing a modulation scheme according to an embodiment. According to embodiments, at least some of the operations described below may be omitted or transformed, or the order thereof may be changed.

Referring to FIG. 5A, in operation 502, the electronic device 101 and the external electronic device 202 may establish a Bluetooth connection (for example, a communication link using Bluetooth classic, Bluetooth legacy, or Bluetooth low energy). In an embodiment, operation 502 may include at least one of operation 402, operation 408, operation 420, operation 422, or operation 426 of FIG. 4. In an embodiment, the electronic device 101 and the external electronic device 202 may determine to use a first packet type including a first codec (“Codec #1”) (for example, one of SBC, AAC, aptX, or SSC) and a first modulation scheme (“Mod #1”) while the Bluetooth connection is established. In an embodiment, the first codec may be a predetermined default codec or a codec having the highest priority in the shared codec list. In an embodiment, the first packet type may be a packet type having the highest priority. For example, in the codec list, the SSC, the AAC, and the SBC may sequentially have the higher priority.

In an embodiment, the first packet type may be determined through operation 420 and operation 422. The first packet type may include a first modulation scheme and the first number of slots. For example, the first packet type may be 2-DH5, the first modulation scheme may be π/4-DQPSK, and the first number of slots may be 5. Accordingly, 2-DH5 may mean a data-high rate (DH) packet including data of 2 to 226 bytes and CRC of 16 bits and transmitted using π/4-DQPSK and 5 slots.

When audio data is generated in operation 504, the electronic device 101 may transmit an audio packet generated using the first codec to the external electronic device 202 by using the first modulation scheme. When the audio data is not generated, operation 504 may be omitted.

In operation 506, the electronic device 101 may determine to change the audio codec to the second codec (“Codec #2”). In an embodiment, as the electronic device 101 receives a user input of configuring the external electronic device 202 as the second codec (for example, the UHQ codec) through a Bluetooth setting menu (for example, an audio setting menu of the electronic device 101 or a setting menu of a wearable app for the external electronic device 202) or starts reproducing a media file that requires a predetermined audio codec (for example, the UHQ codec), the electronic device 101 may determine a codec change. In an embodiment, the electronic device 101 may provide the user with the codec list shared through the codec negotiation procedure (for example, operation 428) in the Bluetooth connection and receive a user input of selecting a codec that the user desires based on the codec list. In an embodiment, the electronic device 101 may determine to use the UHQ codec, based on a file format of the media file required to be reproduced. In an embodiment, the electronic device 101 may determine to change the audio codec for the external electronic device 202 to the second codec (for example, the UHQ codec), based on a request signal received from the external electronic device 202.

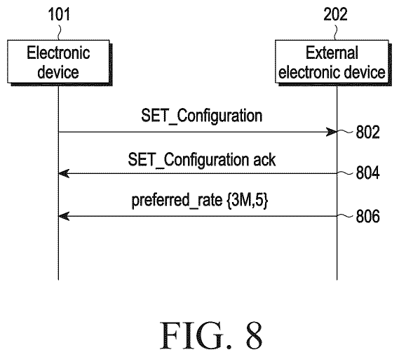

In operation 508, the electronic device 101 and the external electronic device 202 may configure the use of the second codec by performing the codec negotiation procedure. In an embodiment, the codec negotiation procedure may include an operation in which the electronic device 101 sets a codec to be used for audio transmission through the Bluetooth connection. In an embodiment, the codec negotiation procedure may further include an operation in which the electronic device 101 collects at least one piece of codec information that can be supported by the external electronic device 202. In an embodiment, the codec negotiation procedure of operation 508 may include at least some of the operations of FIG. 6 (for example, operation 618 and operation 620) or operation 802 and operation 804 of FIG. 8.

In operation 510, the external electronic device 202 may transmit a change request message (for example, “preferred_rate” of operation 806) for making a request for changing a modulation scheme to the electronic device 101 in response to (or based on) the setting of the second codec. In an embodiment, the change request message may indicate a second demodulation scheme (“Mod #2) (for example, 8 DPSK) or a data rate (for example, 3 Mbps) corresponding to the second modulation scheme. In an embodiment, the change request message may include a value indicating a second packet type (for example, 3-DH5) including the second modulation scheme. In an embodiment, the second codec may generate au audio packet having a larger packet size than the first codec, and the external electronic device 202 may transmit the change request message indicating the second modulation scheme that can transmit larger amounts of data compared to the first modulation scheme in order to support the packet size generated according to the second codec.

In an embodiment, the change request message may include information (for example, a value indicating 3-DH5) indicating the second packet type including the second modulation scheme. In an embodiment, the change request message may include at least one piece of information indicating the second modulation scheme (for example, a value indicating a data rate of 3 Mbps) or information indicating the number of slots (for example, 5). In an embodiment, the external electronic device 202 may identify that the second modulation scheme is one of the supportable modulation schemes shared in operation 502 (for example, operation 420 and operation 422 of FIG. 4) and make a request for the second modulation scheme through the change request message.

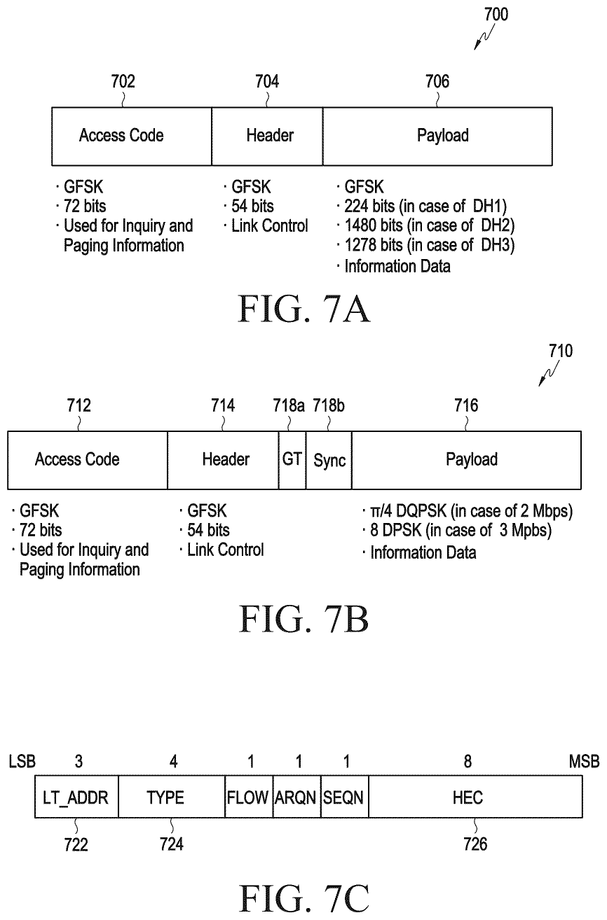

In operation 512a, the electronic device 101 may transmit the first audio packet generated by the second codec (for example, the UHQ codec) to the external electronic device 202 by using the second modulation scheme. The first audio packet may include type information (for example, a type field 724 of FIG. 7C) indicating the second modulation scheme, and the external electronic device 202 may receive the first audio packet by using the second modulation scheme, based on the type information. In operation 512b, the external electronic device 202 may transmit a response packet (for example, ACK or NACK) corresponding to the first audio packet to the electronic device 101.

In an embodiment, the electronic device 101 may provide an audio service by using another modulation scheme (for example, the first modulation scheme) having a lower data rate than the second modulation scheme configured by the change request message of operation 510. For example, the electronic device 101 may transmit a second audio packet generated using the second codec to the external electronic device 202 by using the first modulation scheme or the second modulation scheme, and the external electronic device 202 may transmit a response packet corresponding to the second audio packet to the electronic device 101. At least one audio packet may be transmitted from the electronic device 101 to the external electronic device 202 by using the first modulation scheme or the second modulation scheme while the audio service (for example, reproduction of a media file) is performed in the electronic device 101.

FIG. 5B illustrates a procedure of changing a modulation scheme according to an embodiment, According to embodiments, at least some of the operations described below may be omitted or transformed, or the order thereof may be changed.

Referring to FIG. 5B, operation 520, operation 522, operation 524, operation 526, operation 528, operation 530a, operation 530b, operation 532a, and operation 532b may be similar to operation 502, operation 504, operation 506, operation 508, operation 510, operation 512a, and operation 512b, respectively. For example, in operation 520, the electronic device 101 and the external electronic device 202 may establish a Bluetooth connection configured to use the first codec (for example, the AAC) and the first packet type (for example, 2-DH5). In operation 522, the electronic device 101 may transmit the audio packet generated using the first codec (for example, the AAC) to the external electronic device 202 by using the first packet type (for example, 2-DH5). When the audio data is not generated, operation 522 may be omitted.

In operation 524, the electronic device 101 may determine to change the audio codec to the second codec (for example, the UHQ codec). In operation 526, the electronic device 101 and the external electronic device 202 may configure the use of the second codec by performing the codec negotiation procedure. In operation 528, the external electronic device 202 may transmit a change request message (for example, “preferred_rate” of operation 806) including information (for example, a value indicating 3 Mbps) indicating the second packet type including the second modulation scheme to the electronic device 101.

In operation 530a, the electronic device 101 may transmit the first audio packet generated by the second codec (for example, the UHQ codec) to the external electronic device 202 by using the second packet type (for example, 3-DH5) including the second modulation scheme. In operation 512b, the external electronic device 202 may transmit a response packet (for example, ACK or NACK) corresponding to the first audio packet to the electronic device 101. The electronic device 101 may transmit the second audio packet generated using the second codec to the external electronic device 202 by using the second packet type in operation 532a, and the external electronic device 202 may transmit a response packet corresponding to the second audio packet to the electronic device 101 in operation 532b.

In operation 534, the electronic device 101 may determine to change the audio codec to the default codec (for example, the first codec). In an embodiment, as a user input making a request for changing the audio codec to be used by the external electronic device 202 to the first codec through a Bluetooth setting menu is received or reproduction of a media file that requires the second codec ends, the electronic device 101 may determine a change to the first codec. In an embodiment, the electronic device 101 may determine to use the first codec, based on a file format of the next media file required to be reproduced. In an embodiment, the electronic device 101 may determine to change the audio codec for the external electronic device 202 to the first codec, based on a request signal received from the external electronic device 202. In an embodiment, when the electronic device 101 provides a dual audio service through an additional connection with another audio device while the Bluetooth connection with the external electronic device 202 is maintained, the electronic device 101 may determine the change to the first codec according to requirements of the other audio device.

In an embodiment, the electronic device 101 or the external electronic device 202 may determine the change to the first codec according to a predetermined condition (for example, a communication quality) while Bluetooth communication is performed using the second codec having large amounts of data transmission such as the UHQ codec. For example, in the situation where it is determined that the communication quality is not good based on at least one of an error in a header of a received packet, a plurality of CRC errors, a received signal strength indicator (RSSI) equal to smaller than a threshold, or an increase in a retransmission ratio, the electronic device 101 or the external electronic device 202 may determine to change the second codec currently being used to the default codec (for example, the first codec). In an embodiment, the electronic device 101 may detects deterioration of the communication quality or receive a request signal indicating deterioration of the communication quality (or a signal making a request for changing the codec) from the external electronic device 202 and visually or aurally provide information indicating a codec change (for example, a change to the first codec) to the user. In an embodiment, the electronic device 101 may display a notification message that recommends the change to the first codec and perform operation 536, based on a user input.

In operation 536, the electronic device 101 and the external electronic device 202 may configure the use of the first codec by performing the codec negotiation procedure. In an embodiment, the codec negotiation procedure of operation 536 may include at least some of the operations of FIG. 6 (for example, operation 618 and operation 620) or operation 802 and operation 804 of FIG. 8.

In operation 538, the external electronic device 202 may transmit a change request message (for example, “preferred_rate” of FIG. 8) making a request for using the first packet type including the first modulation scheme to the electronic device 101 in response to (or based on) setting of the first codec. In an embodiment, the change request message may indicate the first modulation scheme (for example, π/4 DQPSK) and a first data rate (for example, 2 Mbps) corresponding to the first modulation scheme. In an embodiment, the change request message may include information indicating the first packet type (for example, a value indicating 2-DH5). In an embodiment, the change request message may include at least one piece of information indicating the first modulation scheme (for example, a value indicating a data rate of 2 Mbps) or information indicating the number of slots (for example, 5).

In operation 540a, the electronic device 101 may transmit the third audio packet generated by the first codec to the external electronic device 202 by using the first packet type (for example, 2-DH5). The first packet type may include the first modulation scheme. The third audio packet may include type information (for example, a type field 724 of FIG. 7C) indicating the first packet type, and the external electronic device 202 may receive the third audio packet by using the first modulation scheme, based on the type information. In operation 540b, the external electronic device 202 may transmit a response packet (for example, ACK or NACK) corresponding to the third audio packet to the electronic device 101. The electronic device 101 may transmit a fourth audio packet to the external electronic device 202 by using the first packet type in operation 542a, and the external electronic device 202 may transmit a response packet corresponding to the forth audio packet to the electronic device 101 in operation 542b. At least one audio packet may be transmitted using the first packet type from the electronic device 101 to the external electronic device 202 while an audio service (for example, reproduction of a media file) is performed in the electronic device 101.

In an embodiment, when reception sensitivity of at least one audio packet is low and thus occupancy of a reception buffer becomes lower than a threshold and sound cut off is generated or the predetermined number of audio packets are not received for a predetermined time while audio packets are received using the second modulation scheme, the external electronic device 202 may transmit a change request message (for example, preferred_rate of operation 538) in order to make the change to the first modulation scheme.

FIG. 6 illustrates a codec negotiation procedure for Bluetooth communication according to an embodiment. According to embodiments, at least some of the operations described below may be omitted or transformed, or the order thereof may be changed.

Referring to FIG. 6, in operation 602, the electronic device 101 may transmit a request message for making a request for an available codec of the external electronic device 202 in the state where establishment of the Bluetooth connection with the external electronic device 202 is completed. In an embodiment, the request message may be a discover message (for example, AVDTP_DISCOVER″) based on an audio/video distribution transport protocol (AVDTP). In operation 604, the external electronic device 202 may transmit a response message (for example, “AVDTP_DISCOVER”) including ID information (for example, IDs 1, 2, and 3) that identifies at least one supported codec to the electronic device 101.

In operation 606, the electronic device 101 may transmit a message (for example, “GET_ALL_CAPABILITIES”) making a request for codec information of ID 1 to the external electronic device 202. In operation 608, the external electronic device 202 may transmit a message (for example, “GET_ALL_CAPABILITIES”) including codec information corresponding to ID 1 (for example, “SBC, 44.1 khz, stereo or mono, and bitpool”) to the electronic device 101.

In operation 610, the electronic device 101 may transmit a message (for example, “GET_ALL_CAPABILITIES”) making a request for codec information of ID 2 to the external electronic device. In operation 612, the external electronic device 202 may transmit a message (for example, “GET_ALL_CAPABILITIES”) including codec information corresponding to ID 2 (for example, “AAC, 44.1 khz or 448 khz, and stereo or mono”) to the electronic device 101.

In operation 614, the electronic device 101 may transmit a message (for example, “GET_ALL_CAPABILITIES”) making a request for codec information of ID 3 to the external electronic device 202. In operation 616, the external electronic device 202 may transmit the message (for example, “GET_ALL_CAPABILITIES”) including codec information (for example, “Vendor Specific codec” or the UHQ codec) corresponding to ID 3 to the electronic device 101. Through operation 602 to operation 616, the electronic device 101 and the external electronic device 202 may share a supportable codec list (for example, IDs, 1, 2, and 3).

In operation 618, the electronic device 101 may transmit, to the external electronic device 202, a configuration message (for example, “SET_Configuration”) for configuring the use of one codec (for example, the codec of ID 3) in the shared codec list for Bluetooth communication with the external electronic device 202. In operation 620, the external electronic device 202 may transmit a configuration ACK message (for example, “SET_Configuration ack”) accepting the use of the codec of ID 3 to the electronic device 101. In one embodiment, the electronic device 101 may determine to generate at least one audio packet transmitted to the external electronic device 202 by using the codec of ID 3. In an embodiment, a SET_Configuration message may be first transmitted by a device (for example, the electronic device 101) making the Bluetooth connection in order to select a high-priority codec.

In operation 622, the external electronic device 202 may transmit a message (for example, “AVDTP_DISCOVER”) for making a request for an available codec of the electronic device 101 to the electronic device 101. In operation 624, the electronic device 101 may transmit, to the external electronic device 202, the message (for example, “AVDTP_DISCOVER”) including ID information (for example, IDs, 1, 2, 3, 4, and 5) that identifies at least one codec supported by the electronic device 101.

In operation 626, the electronic device 101 may transmit a message (for example, “GET_ALL_CAPABILITIES”) making a request for codec information of the external electronic device 202 to the external electronic device 202. In operation 628, the external electronic device 202 may transmit the message (for example, “GET_ALL_CAPABILITIES”) including at least one piece of codec information to the electronic device 101. In an embodiment, operation 626 and operation 628 may be repeatedly performed at least once based on the ID information of operation 624. In an embodiment, the electronic device 101 may omit the operation (for example, operation 618 and operation 620) of setting the codec after operation 626 and operation 628.

The electronic device 101 may determine to start media reproduction in operation 630 and transmit a message (for example, “AVDTP_START”) informing that transmission of audio data will start to the external electronic device 202 in operation 632. In operation 634, the external electronic device 202 may recognize that transmission of the audio data started and transmit an ACK message (for example, “AVDTP_START (ack)”) to the electronic device 101. Thereafter, the electronic device 101 may transmit one or more audio packets including audio data generated using the codec (for example, the codec of ID 3) set in operation 618 and operation 620 to the external electronic device 202.

FIG. 7A, FIG. 7B, and FIG. 7C illustrate formats of data packets transmitted through Bluetooth communication according to embodiments.

Referring to FIG. 7A, a first packet format 700 may be used for a data rate of a maximum of 1 Mbps and may include an access code 701, a header 704, and a payload 706. The access code 702 may include, for example, 72 bits used for inquiry and paging information or used for basic communication and may be modulated to GFSK. The header 704 may include 54 bits used for link control and may be modulated to GFSK. The payload 706 may include information data of 224 bits for DH1, information data of 1480 bits for DH2, and information data of 1278 bits for DH3 according to a packet type. For the first packet format 700, a GFSK modulation scheme may be used in one entire slot.

Referring to FIG. 7B, a second packet format 710 may further include a guard time (GT) 718a and a synchronous sequence 718b in addition to the access code 712, the header 714, and the payload 716. The second packet format 710 may achieve, for example, a data rate of a maximum of 2 Mbps or 3 Mbps according to a modulation scheme of the payload 716. For example, the access code 712 and the header 714 may be modulated to the GFSK modulation scheme, and the payload 716 may be modulated using π/4 DQPSK for the data rate of 2 Mbps and 8 DPSK for the data rate of 3 Mbps. The guard time 178a may have, for example, the length of 5 us and may be inserted to give a time for switching a modulation scheme by a transmitter (for example, the electronic device 101) according to the modulation scheme of the payload 716. The synchronous sequence 718b may have, for example, the length of 11 us and may include some of reference signals for providing a timing reference suitable for a receiver (for example, the external electronic device 202).

Referring to FIG. 7C, the header 704 or 714 may include a logical transport address (LT_ADDR) 722 of 3 bits, a TYPE 724 of 4 bits indicating a packet type, a FLOW indicating stop or go of data transmission, an automatic repeat request number (ARQN), a sequence number (SEQN), and a header error check (HEC). In an embodiment, the TYPE field 724 may include a value indicating one of the packet types in [Table 1].

In an embodiment, the electronic device 101 may include, in the TYPE field 724 of a transmitted data packet (for example, audio packet), a value related to a modulation scheme (for example, a value indicating a packet type including a modulation scheme) applied to the payload (for example, the payload 716) of the data packet. The external electronic device 202 may receive the data packet, identify the modulation scheme applied to the payload 716, based on the TYPE field 724, and appropriately demodulate the payload 716.

FIG. 8 illustrates a procedure of making a request for changing a modulation scheme according to an embodiment. Referring to FIG. 8, in operation 802, the electronic device 101 may determine, for example, a codec change like in operation 506, and transmit a message (for example, “SET_configuration”) for setting a desired new codec (for example, the UHQ) in the pre-shared codec list (for example, the codec information shared through the codec negotiation procedure of FIG. 6) to the external electronic device 202.

In operation 804, the external electronic device 202 may transmit an ACK message (for example, “SET_Configuration ack”) accepting the use of the new codec to the electronic device 101. The external electronic device 202 may determine that the use of a new modulation scheme (for example, the second modulation scheme) different from the existing modulation scheme (for example, the first modulation scheme) is needed by the use of the new codec. In operation 806, the external electronic device 202 may transmit a change request message (for example, “preferred_rate”) for making a request for using the new modulation scheme to the electronic device 101. In an embodiment, the change request message may include a data rate (for example, 3 Mbps) corresponding to the second modulation scheme and the number (for example, 5) of slots. In an embodiment, the change request message may include a value indicating the second packet type corresponding to the second modulation scheme. For example, a third modulation scheme may be 8 DPSK corresponding to 3 Mbps, and the second packet type may be 3-DH3 or 3-DH5.

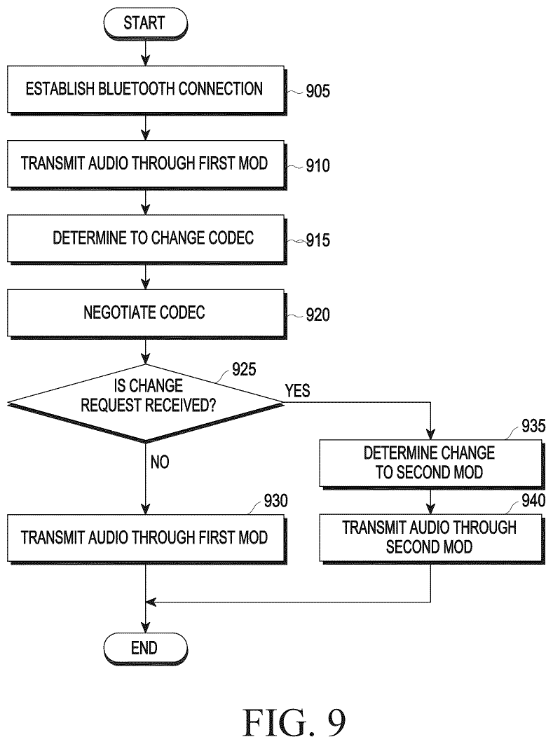

FIG. 9 illustrates operations of the electronic device 101 according to an embodiment. At least one of the following operations may be performed by a processor (for example, the processor 120) of the electronic device 101. According to embodiments, at least some of the following operations may be omitted or transformed, or the order thereof may be changed.

Referring to FIG. 9, in operation 905, the electronic device 101 (for example, the processor 120) may establish a Bluetooth connection with the external electronic device 202. In an embodiment, the electronic device 101 (for example, the processor 120) may establish the Bluetooth connection by performing operation 402, operation 408, operation 420, operation 422, and operation 426. In an embodiment, during establishment of the Bluetooth connection, the electronic device 101 (for example, the processor 120) may determine to use the first codec and the second modulation scheme for the Bluetooth connection. In operation 910, the electronic device 101 (for example, the processor 120) may transmit audio data generated using the first codec to the external electronic device 202 by using the first modulation scheme. When audio data is not generated, operation 910 may be omitted.

In operation 915, the electronic device 101 (for example, the processor 120) may determine a codec change, based on a user input or a file format of a media file. In operation 920, the electronic device 101 (for example, the processor 120) may set a new codec (for example, the second codec) by performing at least some of the codec negotiation procedure (for example, operation 618 and operation 620) with the external electronic device 202 in order to change the codec. In an embodiment, operation 920 may be initiated by the electronic device 101, initiated by the electronic device 101 according to a request from the external electronic device 202, or initiated by the external electronic device 202.

In operation 925, the electronic device (for example, the processor 120) may determine whether a change request message for changing the modulation scheme is received from the external electronic device 202 after performing the codec negotiation procedure. When the change request message is not received, the electronic device 101 (for example, the processor 120) may transmit audio data generated using the second codec to the external electronic device 202 by using the first modulation scheme in operation 930. In an embodiment, the first modulation scheme may include at least one first modulation scheme, and the electronic device 101 (for example, the processor 120) may transmit audio data to the external electronic device 202 by using one selected from at least one first modulation scheme. On the other hand, when a change request message (for example, the change request message of operation 510 or the preferred_rate message of operation 806) making a request for a change to the second modulation scheme is received from the external electronic device 202, the electronic device 101 (for example, the processor 120) may proceed to operation 935.

In operation 935, the electronic device 101 (for example, the processor 120) may determine the change to the second modulation scheme. In an embodiment, the second modulation scheme may include at least one modulation scheme supporting transmission of data having a larger packet size compared to the first modulation scheme. For example, the second modulation scheme may be 8 DPSK corresponding to 3 Mbps. In an embodiment, the electronic device 101 (for example, the processor 120) may transmit an ACK message corresponding to the change request message to the external electronic device 202. In operation 940, the electronic device 101 (for example, the processor 120) may transmit audio data generated using the second codec to the external electronic device 202 by using the second modulation scheme. In an embodiment, the second modulation scheme may include at least one second modulation scheme, and the electronic device 101 (for example, the processor 120) may transmit audio data to the external electronic device 202 by using one selected from at least one second modulation scheme.

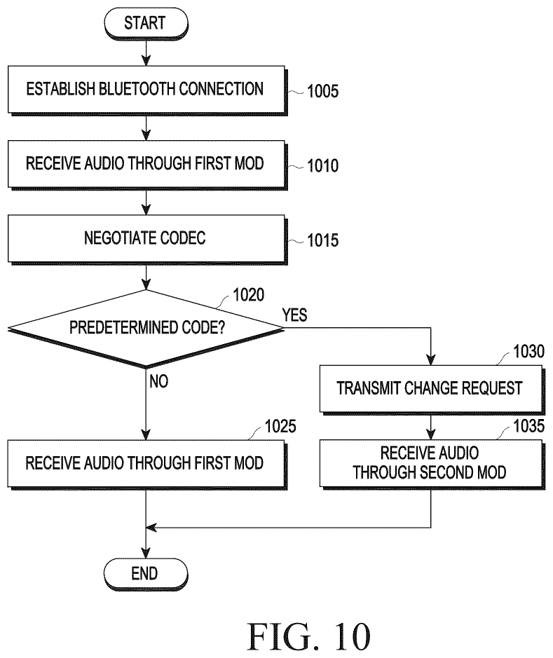

FIG. 10 illustrates operations of the external electronic device 202 according to an embodiment. At least one of the following operations may be performed by a processor (for example, the processor 310) of the external electronic device 202. According to embodiments, at least some of the following operations may be omitted or transformed, or the order thereof may be changed.

Referring to FIG. 10, in operation 1005, the external electronic device 202 (for example, the processor 310) may establish a Bluetooth connection with the electronic device 101. In an embodiment, the external electronic device 202 (for example, the processor 310) may establish the Bluetooth connection by performing operation 402, operation 408, operation 420, operation 422, and operation 426. In an embodiment, during the establishment of the Bluetooth connection, the external electronic device 202 (for example, the processor 310) may identify the use of the first codec and the second modulation scheme for the Bluetooth connection. In operation 1010, the external electronic device 202 (for example, the processor 310) may receive audio data generated using the first codec from the electronic device 101 by using the first modulation scheme. When the audio data is not generated, operation 1010 may be omitted.

In operation 1015, the external electronic device 202 (for example, the processor 310) may set a new codec (for example, the second codec) by performing at least some of the codec negotiation procedure (for example, operation 618 and operation 620) with the electronic device 101. In an embodiment, operation 1015 may be initiated by the electronic device 101, initiated by the electronic device 101 by a request from the external electronic device 202, or initiated by the external electronic device 202.

In operation 1020, the external electronic device 202 (for example, the processor 310) may determine whether the second codec is a predetermined codec (for example, the UHQ codec) that needs a change in the modulation scheme. In an embodiment, the predetermined codec may include at least one codec configured to generate an audio packet having a larger packet size compared to the first codec. When the second codec is not the predetermined codec (for example, the UHQ codec), the external electronic device 202 (for example, the processor 310) may receive audio data generated using the second codec from the electronic device 101 by using the first modulation scheme in operation 1025. On the other hand, when the second codec is the predetermined codec (for example, the UHQ codec), the external electronic device 202 (for example, the processor 310) may proceed to operation 1030.

In operation 1030, the external electronic device 202 (For example, the processor 310) may transmit a change request message making a request for a change to the second modulation scheme to the electronic device 101. In an embodiment, the second modulation scheme may include at least one modulation scheme supporting transmission of data having a larger packet size compared to the first modulation scheme. For example, the second modulation scheme may be 8 DPSK corresponding to 3 Mbps. In an embodiment, the external electronic device 202 (for example, the processor 310) may receive an ACK message corresponding to the change request message from the electronic device 101. In operation 1035, the external electronic device 202 (for example, the processor 310) may receive audio data generated using the second codec from the electronic device 202 by using the second modulation scheme.

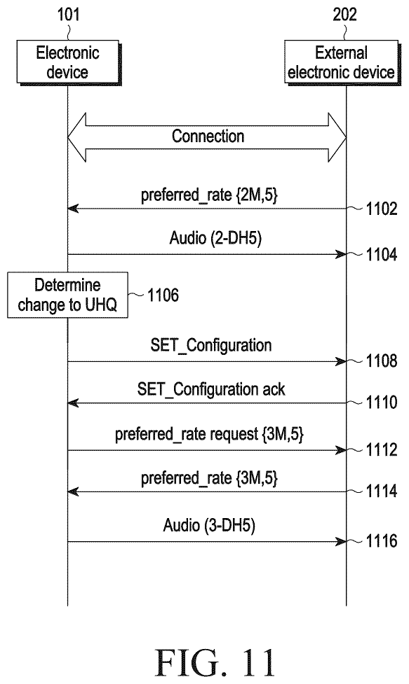

FIG. 11 illustrates a procedure of changing a modulation scheme according to an embodiment. According to embodiments, at least some of the following operations may be omitted or transformed, or the order thereof may be changed.

Referring to FIG. 11, in operation 1102, the electronic device 101 and the external electronic device 202 may establish a Bluetooth connection (for example, a communication link using Bluetooth classic or Bluetooth legacy). In an embodiment, operation 1102 may include at least one of operation 402, operation 408, operation 420, operation 422, or operation 426 of FIG. 4. In an embodiment, the electronic device 101 and the external electronic device 202 may determine to set the first codec (for example, one of the SBC, the AAC, the aptX, or the SSC) while the Bluetooth connection is established.

In operation 1102, the external electronic device 202 may transmit a message (for example, “preferred_rate”) for making a request for a preferred data rate to the electronic device 101. In an embodiment, the preferred rate message may indicate a first packet type (for example, 2-DH5) including the first modulation scheme (for example, π/4 DQPSK) and the first number (for example, 5) of slots. In an embodiment, the preferred rate message may include a value indicating a data rate (for example, 2 Mbps) corresponding to the first modulation scheme. When audio data is generated, the electronic device 101 may transmit an audio packet generated using the first codec to the external electronic device 202 by using the first packet type (for example, 2-DH5) including the first modulation scheme in operation 1104.

In operation 1106, the electronic device 1106 may determine to change the audio codec to the second codec (for example, the UHQ codec). In an embodiment, the electronic device 101 may determine to change the codec, based on a user input or a file format of a media file. In an embodiment, the electronic device 101 may determine to change the audio codec for the external electronic device 202 to the second codec, based on a request signal received from the external electronic device 202.

In operation 1108, the electronic device 101 may transmit a message (for example, “SET_Configuration”) indicating the configuration of the second codec (for example, the UHQ codec) to the external electronic device 202. In operation 1110, the external electronic device 202 may transmit an ACK message (for example, “SET_Configuration ack”) identifying the configuration of the second codec (for example, the UHQ codec) to the electronic device 101.

In operation 1112, the electronic device 101 may transmit a change induction message (for example, “preferred_rate request”) inducing a modulation scheme change to the external electronic device 202. In an embodiment, the second codec may generate an audio packet having a larger packet size compared to the first codec, and the electronic device 101 may induce the preferred_rate of the external electronic device 101 in order to support the packet size generated according to the second codec. In an embodiment, the change induction message may indicate the second modulation scheme (for example, 8 DPSK) or a data rate (for example, 3 Mbps) corresponding to the second modulation scheme. In an embodiment, the change induction message may indicate the second packet type (for example, 3-DH5) including the second modulation scheme. In an embodiment, the change induction message may follow the packet format 1300 of FIG. 8.

In operation 1114, the external electronic device 202 may transmit a change request message (for example, “preferred_rate” of operation 806) for making a request for changing the modulation scheme to the electronic device 101, based on reception of the change induction message. The change request message may indicate the second modulation scheme (for example, 8 DPSK) or a data rate (for example, 3 Mbps) corresponding to the second modulation scheme. In an embodiment, the change request message may make a request for using the second packet type (for example, 3-DH5) including the second modulation scheme. In operation 1116, the electronic device 101 may transmit an audio packet generated by the second codec to the external electronic device 202 by using the second packet type (for example, 3-DH5). The second packet type may include the second modulation scheme.

In an embodiment, the electronic device 101 may omit operation 1112 and operation 1114 after operation 1110 and transmit audio packets to the external electronic device 202 by using the second packet type including the second modulation scheme. The external electronic device 202 may demodulate a payload (for example, the payload 716) within the audio packet by using the second packet type, based on a type field (for example, the type field 724) included in a header of the received audio packet.

In an embodiment, as a user input is received, reproduction of a media file ends, or deterioration of a communication quality is detected after operation 1110, the electronic device 101 may perform operation 534, operation 536, and operation 538 in order to make the change to the first codec and/or the first modulation scheme.

In an embodiment, when deterioration of communication quality is detected while audio packets are received using the second modulation scheme, for example, when reception sensitivity of at least one audio packet is low and thus occupancy of a reception buffer becomes lower than a threshold and sound cut off is generated or the predetermined number of audio packets are not received for a predetermined time, the external electronic device 202 may transmit an operation change request message (for example, preferred_rate of operation 538) in order to make the change to the first modulation scheme.

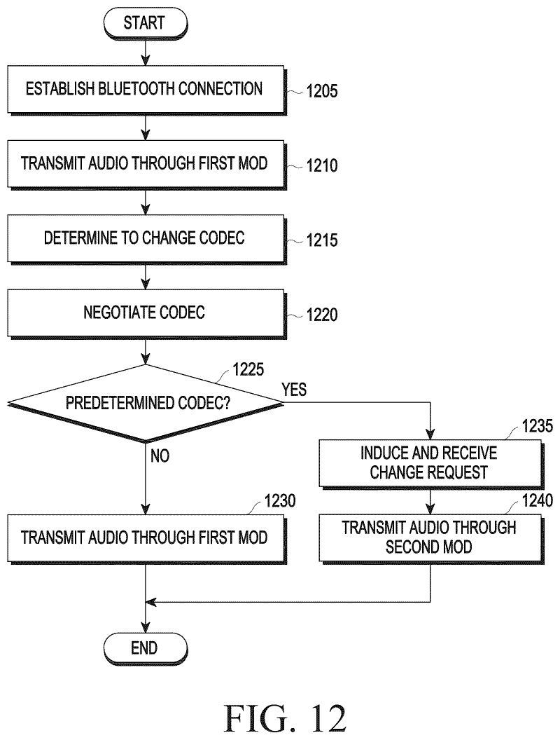

FIG. 12 illustrates a procedure in which the electronic device 101 changes a modulation scheme according to an embodiment. At least one of the following operations may be performed by a processor (for example, the processor 120) of the electronic device 101. According to embodiments, at least some of the following operations may be omitted or transformed, or the order thereof may be changed.

Referring to FIG. 12, in operation 1205, the electronic device 101 (for example, the processor 120) may establish a Bluetooth connection with the external electronic device 202. In an embodiment, the electronic device 101 (for example, the processor 120) may establish the Bluetooth connection by performing operation 402, operation 408, operation 420, operation 422, and operation 426. In an embodiment, the electronic device 101 (for example, the processor 120) may determine to use a first codec and a second modulation scheme for the Bluetooth connection. In operation 1210, the electronic device 101 (for example, the processor 120) may transmit audio data generated using the first codec to the external electronic device 101 by using the first modulation scheme.

In operation 1215, the electronic device 101 (for example, the processor 120) may determine to change the codec, based on a user input (for example, a user input through an audio configuration menu of the electronic device 101 or a wearable app for controlling the external electronic device 202) or a file format of a media file. In an embodiment, the electronic device 101 (for example, the processor 120) may determine to change the codec before the audio service starts, when the connection with the external electronic device 202 is made, or while the audio service is provided.

In operation 1220, the electronic device 101 (for example, the processor 120) may set a new codec (for example, the second codec) by performing at least some of the codec negotiation procedure (for example, operation 618 and operation 620) with the external electronic device 202 in order to change the codec. In an embodiment, operation 1220 may be initiated by the electronic device 101, initiated by the electronic device 101 according to a request from the external electronic device 202, or initiated by the external electronic device 202. In an embodiment, the electronic device 101 (for example, the processor 120) may proceed to operation 1225 in order to set the second codec as the default codec through the codec negotiation while a Bluetooth connection with the external electronic device 202 is established and configure a modulation scheme suitable for the second codec.

In operation 1225, the electronic device 101 (for example, the processor 120) may determine whether the second codec is a predetermined codec (for example, the UHQ codec) that needs a modulation scheme change. When the second codec is not the predetermined codec (for example, the UHQ codec), the electronic device 101 (for example, the processor 120) may receive audio data generated using the second codec from the electronic device 101 by using the first modulation scheme in operation 1230. On the other hand, when the second codec is the predetermined codec (for example, the UHQ codec), the electronic device 101 (for example, the processor 120) may proceed to operation 1235.

In operation 1235, the electronic device 101 (for example, the processor 120) may transmit the change induction message (for example, “preferred_rate request”) inducing the modulation scheme change to the external electronic device 202 and receive a change request message (for example, “preferred_rate”) from the external electronic device 202. In an embodiment, the change induction message may indicate the second modulation scheme (for example, 8 DPSK) or a data rate (for example, 3 Mbps) corresponding to the second modulation scheme. In an embodiment, the change induction message may indicate the second packet type (for example, 3-DH5) including the second modulation scheme. In an embodiment, the external electronic device 202 may receive the change induction message and transmit the change request message including information related to the second modulation scheme to the electronic device 101, based on the change induction message.

In an embodiment, the change induction message may indicate the second modulation scheme (for example, 8 DPSK) or a data rate (for example, 3 Mbps) corresponding to the second modulation scheme, based on the change induction message. In an embodiment, the change request message may indicate the second packet type (for example, 3-DH5) including the second modulation scheme, based on the change induction message. In an embodiment, the electronic device 101 (for example, the processor 120) may transmit an ACK message corresponding to the change request message to the external electronic device 101.

In operation 1240, the electronic device 101 (for example, the processor 120) may receive audio data generated using the second codec from the electronic device 202 by using the second modulation scheme.

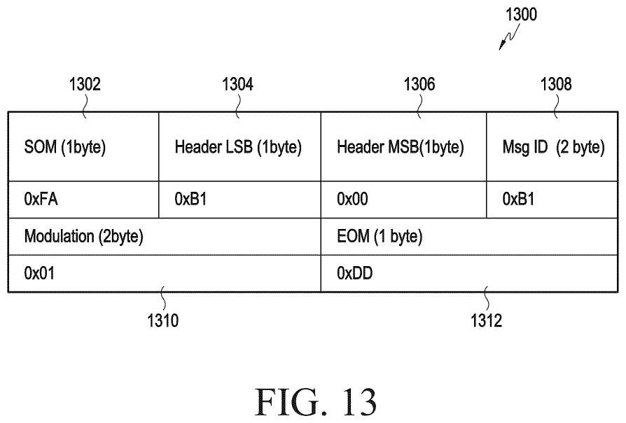

FIG. 13 illustrates a format of a change induction message according to an embodiment. Referring to FIG. 13, a change induction message 1300 may include a start of message (SOM) field 1302, header least significant bits (LSB) 1304, header most significant bits (MSB) 1306, a message ID 1308, a modulation field 1310, and an end of message (EOM) field 1312.

In an embodiment, the modulation field 1310 may include a value indicating a modulation scheme for inducing the electronic device 101 to make a request for changing the modulation scheme to the external electronic device 202. For example, the modulation field 1310 is 2 bytes and may be configured as a value indicating one of the packet types shown in [Table 1].

An electronic device and a method of operating the electronic device according to an embodiment may provide a high-quality audio service to a user by changing a modulation scheme for data transmission according to a codec and/or a transmission mode in an electronic device operating as an audio source and an electronic device receiving audio data.

The electronic device and the method of operating the electronic device according to an embodiment may increase link efficiency and cope with a change in wireless environments changing at least one of a modulation scheme, the number of slots, or a data rate for data transmission according to amounts of data transmission.

The electronic device 101 according to an embodiment may include the communication circuit 190 and at least one processor 120 functionally connected to the communication circuit. The at least one processor may be configured to establish a Bluetooth connection configured to use a first codec and a first modulation scheme for an audio service with the external electronic device 202 through the communication circuit. The at least one processor may be configured to determine to use a second codec in order to reproduce media. The at least one processor may be configured to determine to transmit a configuration message indicating the use of the second codec to the external electronic device through the communication circuit. The at least one processor may be configured to receive a change request message making a request for a change to a second modulation scheme from the external electronic device through the communication circuit after transmitting the configuration message. The at least one processor may be configured to transmit at least one audio packet generated using the second codec to the external electronic device through the communication by using the second modulation scheme.

In an embodiment, the second codec may be an ultra-high quality (UHQ) codec. In an embodiment, the second modulation scheme may include 8-differential phase-shift keying (3 DPSK) supporting a transmission rate of 3 Mbps.

In an embodiment, the change request message may include a preferred rate message including information indicating at least one of the second modulation scheme, a data rate corresponding to the second modulation scheme, or a packet type including the second modulation scheme.

In an embodiment, when a request for reproducing a media file generated using the second codec is detected or a user input for setting the second codec is received, the at least one processor may be configured to determine to use the second codec.

In an embodiment, the at least one processor may be configured to determine whether a modulation scheme change is needed based on the second codec before receiving the change request message and, when the modulation scheme change is needed, transmit a change induction message including information related to the second modulation scheme to the external electronic device through the communication circuit.

In an embodiment, as a user input is received while the at least one audio packet is transmitted using the second modulation scheme, reproduction of the media file ends, or deterioration of a communication quality is detected, the at least one processor may be configured to transmit a configuration message indicating the use of the first codec to the external electronic device, receive a change request message making a request for the change to the first modulation scheme from the external electronic device, and transmit at least one audio packet generated using the first codec to the external electronic device by using the first modulation scheme in response to (or based on) the change request message.

The electronic device according to an embodiment may include the communication circuit 320 and at least one processor functionally connected to the communication circuit. The at least one processor may be configured to establish a Bluetooth connection configured to use a first codec and a first modulation scheme for an audio service with the external electronic device through the communication circuit. The at least one processor may be configured to receive a configuration message indicating use of a second codec for the Bluetooth connection from the external electronic device through the communication circuit. The at least one processor may be configured to determine whether a modulation scheme change is needed based on the second codec. When the modulation scheme change is needed, the at least one processor may be configured to transmit a change request message making a request for a change to a second modulation scheme to the external electronic device through the communication circuit. The at least one processor may be configured to receive at least one audio packet generated using the second codec from the external electronic device through the communication circuit by using the second modulation scheme.

In an embodiment, the second codec may be a UHQ codec. In an embodiment, the second modulation scheme may include 3 DPSK supporting a transmission rate of 3 Mbps.

In an embodiment, the change request message may include a preferred rate message including information indicating at least one of the second modulation scheme, a data rate corresponding to the second modulation scheme, or a packet type including the second modulation scheme.

In an embodiment, the at least one processor may be configured to receive a change induction message including information related to the second modulation scheme from the external electronic device through the communication circuit before transmitting the change request message.

In an embodiment, a method of operating the electronic device may include operation 905 of establishing a Bluetooth connection configured to use a first codec and a first modulation scheme for an audio service with the external electronic device. The method may include an operation of determining to use a second codec in order to reproduce media. The method may include an operation of transmitting a configuration message indicating the use of the second codec to the external electronic device. The method may include operation 925 of receiving a change request message making a request for a change to a second modulation scheme from the external electronic device after transmitting the configuration message. The method may include operation 940 of transmitting at least one audio packet generated using the second codec to the external electronic device by using the second modulation scheme.

In an embodiment, the second codec may be a UHQ codec. In an embodiment, the second modulation scheme may include 3 DPSK supporting a transmission rate, for example, 3 Mbps.

In an embodiment, the change request message may include a preferred rate message including information indicating at least one of the second modulation scheme, a data rate corresponding to the second modulation scheme, or a packet type including the second modulation scheme.

In an embodiment, when a request for reproducing a media file generated using the second codec is detected or a user input for setting the second codec is received, the operation of determining to use the second codec may determine to use the second codec.

In an embodiment, the method may further include an operation of determining whether a modulation scheme change is needed based on the second codec before receiving the change request message and an operation of, when the modulation scheme change is needed, transmitting a change induction message including information related to the second modulation scheme to the external electronic device.

In an embodiment, as a user input is received while the audio data is transmitted using the second modulation scheme, reproduction of the media file ends, or deterioration of a communication quality is detected, the method may further include an operation of transmitting a configuration message indicating the use of the first codec to the external electronic device, an operation of receiving a change request message making a request for the change to the first modulation scheme from the external electronic device, and an operation of transmitting audio data generated using the first codec to the external electronic device by using the first modulation scheme in response to (or based on) the change request message.

The method of operating the electronic device may include an operation of establishing a Bluetooth connection configured to use a first codec and a first modulation scheme for an audio service with the external electronic device. The method may include operation of receiving a configuration message indicating use of a second codec for the Bluetooth connection from the external electronic device. The method may include operation 1020 of determining whether a modulation scheme change is needed based on the second codec. When the modulation scheme change is needed, the method may include an operation of transmitting a change request message making a request for a change to a second modulation scheme to the external electronic device. The method may include operation of receiving audio data generated using the second codec from the external electronic device by using the second modulation scheme.

In an embodiment, the second codec may be a UHQ codec. In an embodiment, the second modulation scheme may include 3 DPSK supporting a transmission rate, for example, 3 Mbps.

In an embodiment, the change request message may include a preferred rate message including information indicating at least one of the second modulation scheme, a data rate corresponding to the second modulation scheme, or a packet type including the second modulation scheme.

In an embodiment, the method may further include an operation of receiving a change induction message including information related to the second modulation scheme from the external electronic device before transmitting the change request message.

The electronic device according to embodiments set forth herein may be one of various types of devices. The electronic device may include, for example, a portable communication device (e.g., a smart phone), a computer device, a portable multimedia device, a portable medical device, a camera, a wearable device, or a home appliance. The electronic device according to embodiments of the disclosure is not limited to those described above.

One or more embodiments of the disclosure and the terms used therein are not intended to limit the technological features set forth herein to particular embodiments and the disclosure includes various changes, equivalents, or alternatives for a corresponding embodiment. With regard to the description of the drawings, similar reference numerals may be used to designate similar or relevant elements. A singular form of a noun corresponding to an item may include one or more of the items, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one or all possible combinations of the items enumerated together in a corresponding one of the phrases. Such terms as “a first,” “a second,” “the first,” and “the second” may be used to simply distinguish a corresponding element from another, and does not limit the elements in other aspect (e.g., importance or order). If an element (e.g., a first element) is referred to, with or without the term “operatively” or “communicatively”, as “coupled with/to” or “connected with/to” another element (e.g., a second element), it means that the element may be coupled/connected with/to the other element directly (e.g., wiredly), wirelessly, or via a third element.

As used in one or more embodiments of the disclosure, the term “module” may include a unit implemented in hardware, software, or firmware, and may be interchangeably used with other terms, for example, “logic,” “logic block,” “component,” or “circuit”. The “module” may be a single integrated component, or a minimum unit or part thereof, adapted to perform one or more functions. For example, according to an embodiment, the “module” may be implemented in the form of an application-specific integrated circuit (ASIC).

One or more embodiments of the disclosures may be implemented as software (e.g., the program 140) including one or more instructions that are stored in a storage medium (e.g., the internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it. This allows the machine to be operated to perform at least one function according to the at least one instruction invoked. The one or more instructions each may include a code generated by a complier or a code executable by an interpreter. The machine-readable storage medium may be provided in the form of a non-transitory storage medium. Herein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, methods according to one or more embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to one or more embodiments, each element (e.g., a module or a program) of the above-described elements may include a single entity or multiple entities, and some of the multiple entities may be separately disposed in another element. According to one or more embodiments, one or more of the above-described elements or operations may be omitted, or one or more other elements or operations may be added. Alternatively or additionally, a plurality of elements (e.g., modules or programs) may be integrated into a single element. In such a case, according to one or more embodiments, the integrated element may still perform one or more functions of each of the plurality of elements in the same or similar manner as they are performed by a corresponding one of the plurality of elements before the integration. According to one or more embodiments, operations performed by the module, the program, or another element may be carried out sequentially, in parallel, repeatedly, or heuristically, or one or more of the operations may be executed in a different order or omitted, or one or more other operations may be added.

What is claimed is:

1. An electronic device comprising:
a communication circuit;
memory storing instructions; and
at least one processor operatively connected to the communication circuit and the memory,
wherein the instructions, when executed by the at least one processor individually or collectively, cause the electronic device to:
establish a communication connection configured to use a first codec and a first modulation scheme for an audio service with an external electronic device through the communication circuit;
determine to use a second codec for reproducing a media file;
transmit, to the external electronic device through the communication circuit, a first configuration message indicating the use of the second codec;
after transmitting the first configuration message, receive, through the communication circuit from the external electronic device, a first change request message for a change from the first modulation scheme to a second modulation scheme; and
transmit, to the external electronic device through the communication circuit, at least one audio packet generated using the second codec by using the second modulation scheme.

2. The electronic device of claim 1, wherein the second codec is an ultra-high quality (UHQ) codec, and
wherein the second modulation scheme comprises 8-differential phase-shift keying (8 DPSK) supporting a transmission rate that is about or equal to 3 Mbps.

3. The electronic device of claim 1, wherein the first change request message comprises a preferred rate message comprising information indicating at least one of the second modulation scheme, a data rate corresponding to the second modulation scheme, or a packet type comprising the second modulation scheme.

4. The electronic device of claim 1, wherein the instructions, when executed by the at least one processor individually or collectively, further cause the electronic device to, based on a request for reproducing the media file generated using the second codec being detected or a user input for setting the second codec being received, determine to use the second codec.

5. The electronic device of claim 1, wherein the instructions, when executed by the at least one processor individually or collectively, further cause the electronic device to:
determine whether a modulation scheme change is needed based on the second codec before receiving the first change request message; and
based on determining that the modulation scheme change is needed, transmit, to the external electronic device through the communication circuit, a change induction message comprising information related to the second modulation scheme.

6. The electronic device of claim 1, wherein the instructions, when executed by the at least one processor individually or collectively, further cause the electronic device to:
based on a user input being received while the at least one audio packet is transmitted using the second modulation scheme, reproduction of the media file being terminated, or deterioration of a communication quality being detected, transmit, to the external electronic device, a second configuration message indicating the use of the first codec;
receive, from the external electronic device, a second change request message for the change from the second modulation scheme to the first modulation scheme; and
transmit at least one audio packet generated using the first codec to the external electronic device by using the first modulation scheme based on the second change request message.

7. An electronic device comprising:
a communication circuit;
memory storing instructions; and
at least one processor operatively connected to the communication circuit and the memory,
wherein the instructions, when executed by the at least one processor individually or collectively, cause the electronic device to:
establish a communication connection configured to use a first codec and a first modulation scheme for an audio service with an external electronic device through the communication circuit;
receive, from the external electronic device through the communication circuit, a first configuration message indicating use of a second codec for the communication connection;
determine whether a modulation scheme change is needed based on the second codec;
based on determining that the modulation scheme change is needed, transmit a first change request message for a change from the first modulation scheme to a second modulation scheme to the external electronic device through the communication circuit; and
receive, from the external electronic device through the communication circuit, at least one audio packet generated using the second codec by using the second modulation scheme.

8. The electronic device of claim 7, wherein the second codec is a UHQ codec, and
wherein the second modulation scheme comprises 8 DPSK supporting a transmission rate of 3 Mbps.

9. The electronic device of claim 7, wherein the first change request message comprises a preferred rate message comprising information indicating at least one of the second modulation scheme, a data rate corresponding to the second modulation scheme, or a packet type comprising the second modulation scheme.

10. The electronic device of claim 7, wherein the instructions, when executed by the at least one processor individually or collectively, further cause the electronic device to receive, from the external electronic device through the communication circuit, a change induction message comprising information related to the second modulation scheme before transmitting the first change request message.

11. A method by an electronic device, the method comprising:
establishing a communication connection configured to use a first codec and a first modulation scheme for an audio service with an external electronic device;
determining to use a second codec for reproducing a media file;
transmitting, to the external electronic device, a first configuration message indicating the use of the second codec;
after transmitting the first configuration message, receiving, from the external electronic device, a first change request message for a change from the first modulation scheme to a second modulation scheme; and
transmitting, to the external electronic device, at least one audio packet generated using the second codec by using the second modulation scheme.

12. The method of claim 11, wherein the second codec is a UHQ codec, and
wherein the second modulation scheme comprises 8 DPSK supporting a transmission rate of 3 Mbps.

13. The method of claim 11, wherein the first change request message comprises a preferred rate message comprising information indicating at least one of the second modulation scheme, a data rate corresponding to the second modulation scheme, or a packet type comprising the second modulation scheme.

14. A method of operating an electronic device, the method comprising:
establishing a communication connection configured to use a first codec and a first modulation scheme for an audio service with an external electronic device;
receiving, from the external electronic device, a first configuration message indicating use of a second codec for the communication connection;
determining whether a modulation scheme change is needed based on the second codec;
in case that the modulation scheme change is needed, transmitting, to the external electronic device, a first change request message for a change from the first modulation scheme to a second modulation scheme; and
receiving, from the external electronic device, audio data generated using the second codec by using the second modulation scheme.

15. The method of claim 14, wherein the second codec is a UHQ codec, and
wherein the second modulation scheme comprises 8 DPSK supporting a transmission rate of 3 Mbps.

16. The method of claim 11, wherein the determining to use the second codec comprises, based on a request for reproducing the media file generated using the second codec being detected or a user input for setting the second codec being received, determine to use the second codec.

17. The method of claim 11, further comprising:
determining whether a modulation scheme change is needed based on the second codec before receiving the first change request message; and
based on determining that the modulation scheme change being needed, transmitting, to the external electronic device, a change induction message comprising information related to the second modulation scheme.

18. The method of claim 11, further comprising:
based on a user input being received while the at least one audio packet is transmitted using the second modulation scheme, reproduction of the media file being terminated, or deterioration of a communication quality being detected, transmitting, to the external electronic device, a second configuration message indicating the use of the first codec;
receiving, from the external electronic device, a second change request message for the change from the second modulation scheme to the first modulation scheme; and
transmitting at least one audio packet generated using the first codec to the external electronic device by using the first modulation scheme based on the second change request message.

19. The method of claim 14, wherein the first change request message comprises a preferred rate message comprising information indicating at least one of the second modulation scheme, a data rate corresponding to the second modulation scheme, or a packet type comprising the second modulation scheme.

20. The method of claim 14, further comprising, before transmitting the first change request message, receiving, from the external electronic device, a change induction message comprising information related to the second modulation scheme.
